(19) United States
(12) Patent Application Publication
(10) Pub. No.: US 2024/0370205 A1
(43) Pub. Date: Nov. 7, 2024

(54) ACCESSING MULTIPLE SEGMENTS OF MEMORY SYSTEMS

(71) Applicant: Micron Technology, Inc., Boise, ID (US)

(72) Inventor: Martin Brox, Munich (DE)

(21) Appl. No.: 18/652,396

(22) Filed: May 1, 2024

Related U.S. Application Data
(60) Provisional application No. 63/464,347, filed on May 5, 2023.

(51) Int. Cl. G06F 3/06

(52) U.S. Cl. CPC G06F 3/0659; G06F 3/0604; G06F 3/0673

(57) ABSTRACT

Methods, systems, and devices for accessing multiple segments of memory systems are described. A memory device may be configured to concurrently activate two or more segments in a same row of a bank of memory cells based on determining whether the segments are concurrently accessible. For example, during a concurrent access operation on two memory cells in two segments of the same row, the memory device may determine whether the segments are concurrently inaccessible. If the segments are concurrently inaccessible, the memory device may discard a later access command or wait to perform the later access command until the corresponding segment is accessible. If the segments are concurrently accessible, the memory device may access both segments at least partially concurrently. The memory device may transmit an indication to a host device based on determining whether the concurrent access operation may be performed.

### CROSS REFERENCE

The present application for patent claims priority to U.S. Patent Application No. 63/464,347 by Brox, entitled “ACCESSING MULTIPLE SEGMENTS OF MEMORY SYSTEMS,” filed May 5, 2023, which is assigned to the assignee hereof, and which is expressly incorporated by reference in its entirety herein.

### TECHNICAL FIELD

The following relates to one or more systems for memory, including accessing multiple segments of memory systems.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells in a non-volatile configuration may maintain stored logic states for extended periods of time even in the absence of an external power source. Memory cells in a volatile configuration may lose stored states when disconnected from an external power source.

### BRIEF DESCRIPTION OF THE DRAWINGS

FIG. 1 shows an example of a system that supports accessing multiple segments of memory systems in accordance with examples as disclosed herein.

FIG. 2 shows an example of a bank of memory cells that supports accessing multiple segments of memory systems in accordance with examples as disclosed herein.

FIG. 3 shows an example of a process flow that supports accessing multiple segments of memory systems in accordance with examples as disclosed herein.

FIG. 4 shows a block diagram of a memory device that supports accessing multiple segments of memory systems in accordance with examples as disclosed herein.

FIG. 5 shows a flowchart illustrating a method or methods that support accessing multiple segments of memory systems in accordance with examples as disclosed herein.

### DETAILED DESCRIPTION

Some memory devices (e.g., dynamic random access memory (DRAM) devices) may implement one or more banks of memory cells (e.g., DRAM memory cells), which may be accessed via rows (e.g., rows of word lines), where each row is associated with a plurality of segments each corresponding to a digit line. In some cases, accessing a memory cell from a bank of memory cells may include accessing (e.g., activating) a segment (e.g., a digit line) corresponding to the memory cell. However, accessing the segment may prohibit accessing other segments in a same row. In some such cases, the bank of memory cells may be prohibited from opening another row during accessing the segment. In some examples, accessing the memory cell may include performing a write back procedure that may be associated with causing increased latency for accessing the bank of memory cells, such that an inability to access other segments in the same row or other rows in the bank may further propagate the increased latency due to a lack of concurrent access of other memory cells. To address these issues, some memory devices may implement an increased quantity of banks to allow an increased amount of parallel accesses of memory cells. However, increasing the quantity of banks may be associated with increasing costs or decreasing spatial efficiency, or both of the memory device.

In accordance with examples as described herein, a memory device may be configured to selectively access one or more other segments (e.g., accessible segments) of a bank concurrently with accessing the segment (e.g., an active segment), based on determining whether the one or more other segments are inaccessible (e.g., inaccessible segments) during accessing the segment. For example, segments of a bank may share sense components (e.g., adjacent segments) and may be concurrently inaccessible (e.g., cannot be activated in parallel), however other segments may be capable of being concurrently accessed. In some cases, during a concurrent access operation on two memory cells in two different segments of a bank, the memory device may determine whether the segments are concurrently inaccessible (e.g., one segment is an active segment, one segment is an inaccessible segment). If the segments are concurrently inaccessible, the memory device may discard a later access command (e.g., an access command received after a first access command, an activate command) or wait to perform the later access command until the corresponding segment is concurrently accessible. If the segments are concurrently accessible (e.g., one segment is an active segment, one segment is an accessible segment), the memory device may access both segments at least partially concurrently. In some examples, the memory device may transmit an indication (e.g., an activate command flag) to a host device coupled with the memory device based on determining whether the concurrent access operation may be performed. Accessing memory cells in two or more segments of a same row of a same bank concurrently may decrease latency for accessing the bank (e.g., compared to previous implementations) without increasing a quantity of banks in the memory device (e.g., otherwise associated with previous implementations), thereby conserving costs and space at the memory device.

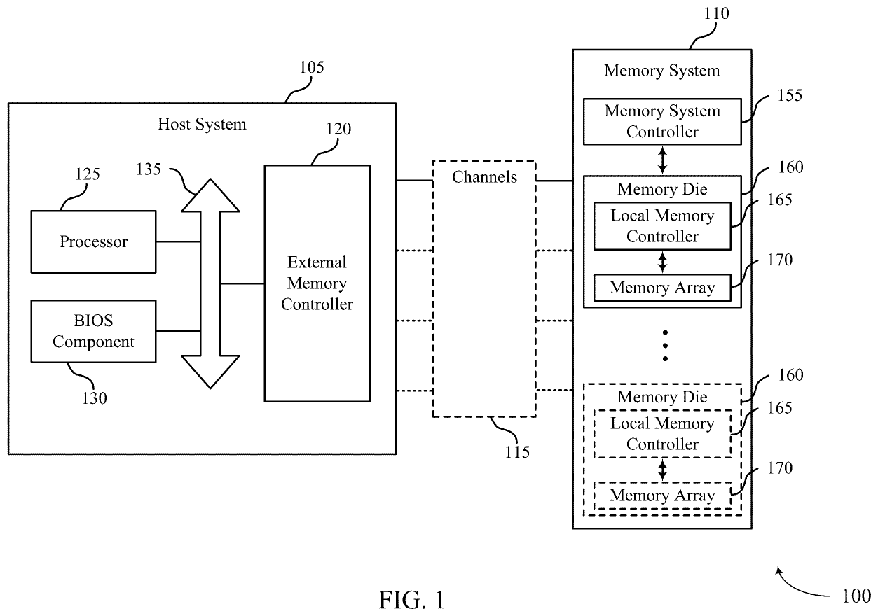

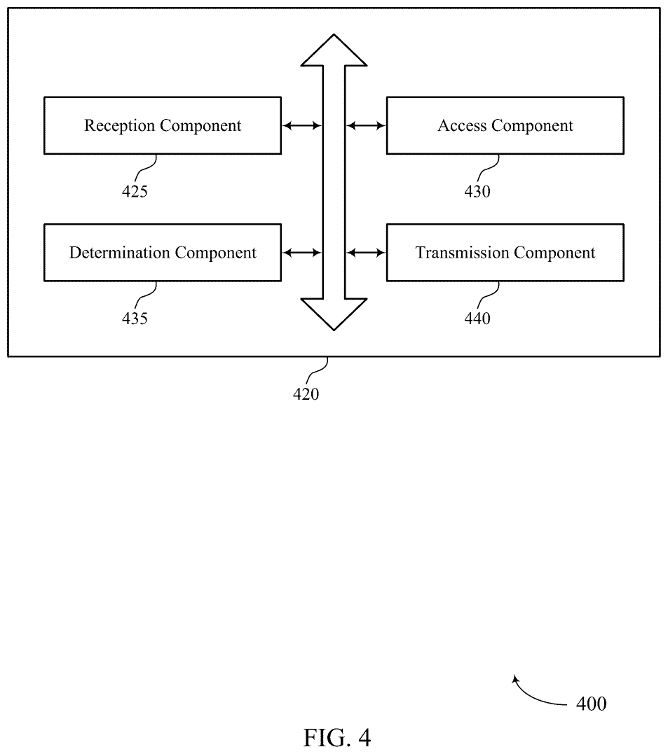

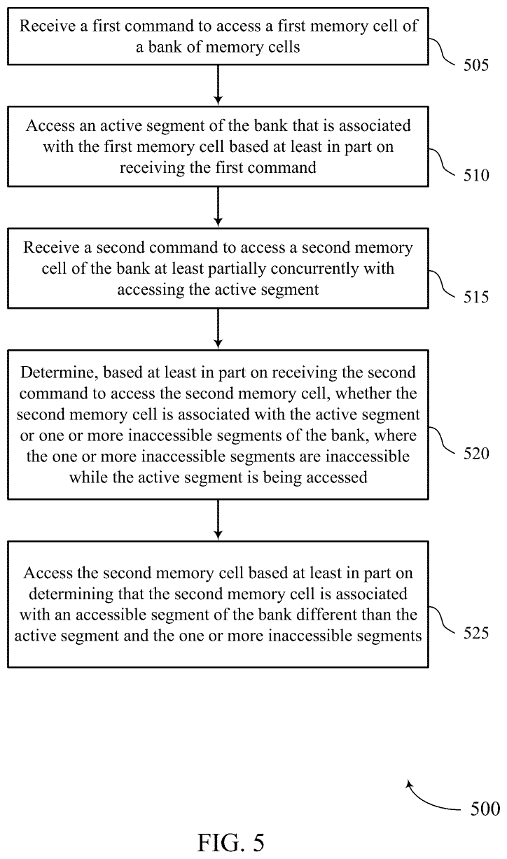

Features of the disclosure are initially described in the context of a system, a bank of memory cells, and a process flow as described with reference to FIGS. 1 through 3. These and other features of the disclosure are further illustrated by and described with reference to an apparatus diagram and flowcharts that relate to accessing multiple segments of memory systems as described with reference to FIGS. 4 and 5.

FIG. 1 shows an example of a system 100 that supports accessing multiple segments of memory systems in accordance with examples as disclosed herein. The system 100 may include a host system 105, a memory system 110, and a plurality of channels 115 coupling the host system 105 with the memory system 110. The system 100 may include one or more memory systems 110, but aspects of the one or more memory systems 110 may be described in the context of a single memory system (e.g., memory system 110).

The system 100 may include portions of an electronic device, such as a computing device, a mobile computing device, a wireless device, a graphics processing device, a vehicle, or other systems. For example, the system 100 may illustrate aspects of a computer, a laptop computer, a tablet computer, a smartphone, a cellular phone, a wearable device, an internet-connected device, a vehicle controller, or the like. The memory system 110 may be a component of the system 100 that is operable to store data for one or more other components of the system 100.

Portions of the system 100 may be examples of the host system 105. The host system 105 may be an example of a processor (e.g., circuitry, processing circuitry, a processing component) within a device that uses memory to execute processes, such as within a computing device, a mobile computing device, a wireless device, a graphics processing device, a computer, a laptop computer, a tablet computer, a smartphone, a cellular phone, a wearable device, an internet-connected device, a vehicle controller, a system on a chip (SoC), or some other stationary or portable electronic device, among other examples. In some examples, the host system 105 may refer to the hardware, firmware, software, or any combination thereof that implements the functions of an external memory controller 120. In some examples, the external memory controller 120 may be referred to as a host (e.g., host system 105).

A memory system 110 may be an independent device or a component that is operable to provide physical memory addresses/space that may be used or referenced by the system 100. In some examples, a memory system 110 may be configurable to work with one or more different types of host devices. Signaling between the host system 105 and the memory system 110 may be operable to support one or more of: modulation schemes to modulate the signals, various pin configurations for communicating the signals, various form factors for physical packaging of the host system 105 and the memory system 110, clock signaling and synchronization between the host system 105 and the memory system 110, timing conventions, or other functions.

The memory system 110 may be operable to store data for the components of the host system 105. In some examples, the memory system 110 (e.g., operating as a secondary-type device to the host system 105, operating as a dependent-type device to the host system 105) may respond to and execute commands provided by the host system 105 through the external memory controller 120. Such commands may include one or more of a write command for a write operation, a read command for a read operation, a refresh command for a refresh operation, or other commands.

The host system 105 may include one or more of an external memory controller 120, a processor 125, a basic input/output system (BIOS) component 130, or other components such as one or more peripheral components or one or more input/output controllers. The components of the host system 105 may be coupled with one another using a bus 135.

The processor 125 may be operable to provide functionality (e.g., control functionality) for the system 100 or the host system 105. The processor 125 may be a general-purpose processor, a digital signal processor (DSP), an application-specific integrated circuit (ASIC), a field-programmable gate array (FPGA) or other programmable logic device, discrete gate or transistor logic, discrete hardware components, or any combination of these components. In such examples, the processor 125 may be an example of a central processing unit (CPU), a graphics processing unit (GPU), a general purpose GPU (GPGPU), or an SoC, among other examples. In some examples, the external memory controller 120 may be implemented by or be a part of the processor 125.

The BIOS component 130 may be a software component that includes a BIOS operated as firmware, which may initialize and run various hardware components of the system 100 or the host system 105. The BIOS component 130 may also manage data flow between the processor 125 and the various components of the system 100 or the host system 105. The BIOS component 130 may include instructions (e.g., a program, software) stored in one or more of read-only memory (ROM), flash memory, or other non-volatile memory.

The memory system 110 may include a memory system controller 155 and one or more memory dies 160 (e.g., memory chips) to support a capacity (e.g., a desired capacity, a specified capacity) for data storage. Each memory die 160 (e.g., memory die 160-a, memory die 160-b, memory die 160-N) may include a local memory controller 165 (e.g., local memory controller 165-a, local memory controller 165-b, local memory controller 165-N) and a memory array 170 (e.g., memory array 170-a, memory array 170-b, memory array 170-N). A memory array 170 may be a collection (e.g., one or more grids, one or more banks, one or more tiles, one or more sections) of memory cells, with each memory cell being operable to store one or more bits of data. A memory system 110 including two or more memory dies 160 may be referred to as a multi-die memory or a multi-die package or a multi-chip memory or a multi-chip package.

A memory die 160 may be an example of a two-dimensional (2D) array of memory cells or may be an example of a three-dimensional (3D) array of memory cells. In some examples, a 2D memory die 160 may include a single memory array 170. In some examples, a 3D memory die 160 may include two or more memory arrays 170, which may be stacked on top of one another or positioned next to one another (e.g., relative to a substrate). In some examples, memory arrays 170 in a 3D memory die 160 may be referred to as or otherwise include different sets (e.g., decks, levels, layers, dies). A 3D memory die 160 may include any quantity of stacked memory arrays 170 (e.g., two high, three high, four high, five high, six high, seven high, eight high). In some 3D memory dies 160, different decks may share a common access line such that some decks may share one or more of a word line, a digit line, or a plate line.

The memory system controller 155 may include components (e.g., circuitry, logic) operable to control operation of the memory system 110. The memory system controller 155 may include hardware, firmware, or instructions that enable the memory system 110 to perform various operations and may be operable to receive, transmit, or execute commands, data, or control information related to the components of the memory system 110. The memory system controller 155 may be operable to communicate with one or more of the external memory controller 120, the one or more memory dies 160, or the processor 125. In some examples, the memory system controller 155 may control operation of the memory system 110 described herein in conjunction with the local memory controller 165 of the memory die 160.

In some examples, the memory system 110 may communicate information (e.g., data, commands, or both) with the host system 105. For example, the memory system 110 may receive a write command indicating that the memory system 110 is to store data received from the host system 105, or receive a read command indicating that the memory system 110 is to provide data stored in a memory die 160 to the host system 105, among other types of information communication.

A local memory controller 165 (e.g., local to a memory die 160) may include components (e.g., circuitry, logic) operable to control operation of the memory die 160. In some examples, a local memory controller 165 may be operable to communicate (e.g., receive or transmit data or commands or both) with the memory system controller 155. In some examples, a memory system 110 may not include a memory system controller 155, and a local memory controller 165 or the external memory controller 120 may perform various functions described herein. As such, a local memory controller 165 may be operable to communicate with the memory system controller 155, with other local memory controllers 165, or directly with the external memory controller 120, or the processor 125, or any combination thereof. Examples of components that may be included in the memory system controller 155 or the local memory controllers 165 or both may include receivers for receiving signals (e.g., from the external memory controller 120), transmitters for transmitting signals (e.g., to the external memory controller 120), decoders for decoding or demodulating received signals, encoders for encoding or modulating signals to be transmitted, or various other components operable for supporting described operations of the memory system controller 155 or local memory controller 165 or both.

The external memory controller 120 may be operable to enable communication of information (e.g., data, commands, or both) between components of the system 100 (e.g., between components of the host system 105, such as the processor 125, and the memory system 110). The external memory controller 120 may process (e.g., convert, translate) communications exchanged between the components of the host system 105 and the memory system 110. In some examples, the external memory controller 120, or other component of the system 100 or the host system 105, or its functions described herein, may be implemented by the processor 125. For example, the external memory controller 120 may be hardware, firmware, or software, or some combination thereof implemented by the processor 125 or other component of the system 100 or the host system 105. Although the external memory controller 120 is depicted as being external to the memory system 110, in some examples, the external memory controller 120, or its functions described herein, may be implemented by one or more components of a memory system 110 (e.g., a memory system controller 155, a local memory controller 165) or vice versa.

The components of the host system 105 may exchange information with the memory system 110 using one or more channels 115. The channels 115 may be operable to support communications between the external memory controller 120 and the memory system 110. Each channel 115 may be an example of a transmission medium that carries information between the host system 105 and the memory system 110. Each channel 115 may include one or more signal paths (e.g., a transmission medium, a conductor) between terminals associated with the components of the system 100. A signal path may be an example of a conductive path operable to carry a signal. For example, a channel 115 may be associated with a first terminal (e.g., including one or more pins, including one or more pads) at the host system 105 and a second terminal at the memory system 110. A terminal may be an example of a conductive input or output point of a device of the system 100, and a terminal may be operable to act as part of a channel.

Channels 115 (and associated signal paths and terminals) may be dedicated to communicating one or more types of information. For example, the channels 115 may include one or more command and address (CA) channels 186, one or more clock signal (CK) channels 188, one or more data (DQ) channels 190, one or more other channels 192, or any combination thereof. In some examples, signaling may be communicated over the channels 115 using single data rate (SDR) signaling or double data rate (DDR) signaling. In SDR signaling, one modulation symbol (e.g., signal level) of a signal may be registered for each clock cycle (e.g., on a rising or falling edge of a clock signal). In DDR signaling, two modulation symbols (e.g., signal levels) of a signal may be registered for each clock cycle (e.g., on both a rising edge and a falling edge of a clock signal).

In accordance with examples as described herein, a memory die 160 may implement one or more banks of memory cells (e.g., DRAM memory cells) in a memory array 170, which may be accessed via rows (e.g., rows of word lines), where each row is associated with a plurality of segments each corresponding to a digit line. In some cases, accessing a memory cell from a bank of memory cells may include accessing a segment (e.g., a digit line, an active segment) corresponding to the memory cell. The memory die 160 may be configured to selectively access one or more other segments (e.g., accessible segments) concurrently with activating the segment based on determining whether the one or more other segments are inaccessible during accessing the segment. For example, segments sharing sense components (e.g., adjacent segments) may be concurrently inaccessible (e.g., cannot be activated in parallel), however other segments may be concurrently accessed. In some cases, during a concurrent access operation on two memory cells in two different segments, the memory die 160 may determine whether the segments are concurrently inaccessible (e.g., one segment is an active segment, one segment is an inaccessible segment). If the segments are concurrently inaccessible, the memory die 160 may discard a later access command (e.g., an access command received after a first access command, an activate command) or wait to perform the later access command until the corresponding segment is concurrently accessible (e.g., one segment is an inaccessible segment). If the segments are concurrently accessible, the memory die 160 may access both segments at least partially concurrently. In some examples, the memory die 160 may transmit an indication (e.g., an activate command flag) to the host system 105 based on determining whether the concurrent access operation may be performed. Accessing memory cells in two or more segments of a same row concurrently may decrease latency (e.g., associated with write-back time) for accessing the bank (e.g., compared to previous implementations) without increasing a quantity of banks in the memory die 160 (e.g., otherwise associated with previous implementations), thereby conserving costs and space at the memory die 160.

In addition to applicability in memory systems as described herein, techniques for accessing multiple segments of memory systems may be generally implemented to improve the performance (including gaming) of various electronic devices and systems. Some electronic device applications, including gaming and other high-performance applications, may be associated with relatively high processing requirements while also benefitting from relatively quick response times to improve user experience. As such, increasing processing speed, decreasing response times, or otherwise improving the performance electronic devices may be desirable. Implementing the techniques described herein may improve the performance of electronic devices by enabling concurrent access of memory cells within a same row of a bank of memory cells, which may decrease processing or latency times, improve response times, or otherwise improve user experience, among other benefits.

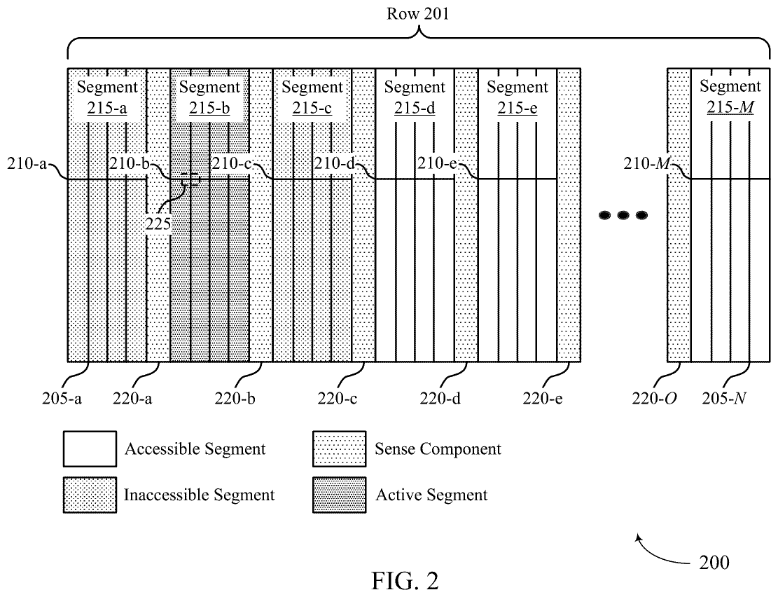

FIG. 2 shows an example of a bank of memory cells 200 that supports accessing multiple segments of memory systems in accordance with examples as disclosed herein. The bank of memory cells 200 may be implemented at a system 100, or implement aspects of a system 100, as described with reference to FIG. 1. For example, the bank of memory cells 200 may be implemented in a memory system 110, a memory die 160, or a memory array 170, as described with reference to FIG. 1. The bank of memory cells 200 may be configured to support concurrent access of memory cells within a same row of the bank of memory cells 200, which may decrease latency associated with accessing the bank of memory cells 200.

The bank of memory cells 200 illustrates a row 201 of the bank of memory cells 200. In some cases, the bank of memory cells 200 may include one or more additional rows 201 (e.g., not shown). The row 201 includes a quantity of word lines 205 (e.g., word line 205-a to word line 205-N, where N may indicate the quantity of word lines 205). For example, the quantity of word lines 205 in the row 201 may be 1000 word lines 205 (e.g., N=1000). The bank of memory cells 200 includes a quantity of digit lines 210 (e.g., digit line 210-a to digit line 210-M, where M may indicate the quantity of digit lines 210). For example, the quantity of digit lines 210 in the bank of memory cells 200 may be 32 digit lines 210 (e.g., M=32). Each digit line 210 may be associated with (e.g., form) a respective segment 215, such that the bank of memory cells 200 may include a quantity of segments 215 corresponding to the quantity of digit lines 210. For example, the bank of memory cells 200 may include 32 segments 215. The bank of memory cells 200 includes a quantity of sense components 220 (e.g., sense component 220-a to sense component 220-O, where O may indicate the quantity of sense components 220), which may each include one or more sense amplifiers. In some cases, the quantity of sense components 220 may correspond to the quantity of segments 215 (e.g., O=M), such that each sense component 220 may be associated with a corresponding segment 215 (e.g., sense component 220-a may correspond to segment 215-a). However, in other cases, the quantity of sense components 220 may be different from the quantity of segments 215 (e.g., O≠M), such that each sense component 220 may be associated with one or more segments 215.

Each word line 205 may be coupled with a respective subset of one or more memory cells (e.g., memory cells 225) of the bank of memory cells 200. Similarly, each digit line 210 (e.g., each segment 215) may be coupled with a respective second subset of memory cells (e.g., memory cells 225) of the bank of memory cells 200, such that a quantity of memory cells in each second subset of memory cells is equivalent to the quantity of word lines 205 associated with the respective segment 215. Accessing a memory cell 225 of the bank of memory cells 200 may include applying a voltage to a corresponding word line 205, where satisfying a gate of the word line 205 (e.g., via the voltage applied) may enable a corresponding digit line 210 to carry a voltage to the memory cell 225 (e.g., due to the digit line 210 becoming conductive and coupling with the memory cell 225).

In some cases, each sense component 220 may be configured to support sensing a respective second subset of memory cells associated with the corresponding segment 215. For example, each sense component 220 may be coupled with a respective digit line 210 and configured to sense the memory cells 225 associated with the respective digit line 210. However, in some cases, each sense component 220 may be configured to support sensing the memory cells 225 associated with two respective segments 215 adjacent to the sense component 220, or may be coupled with two respective segments 215 adjacent to the sense component 220. For example, the sense component 220-a may be coupled with the segment 215-a and a segment 215-b (e.g., both adjacent to the sense component 220-a).

In some applications, a bank of memory cells may not support concurrently (e.g., occurring at least partially during a same time interval) accessing multiple segments in a same row. For example, performing an access operation (e.g., a write-back operation, in which a logic state is rewritten to a memory cell after reading the memory cell) on a memory cell in a segment (e.g., an active segment) of the bank of memory cells may prevent performing other access operations (e.g., write-back operations) on other memory cells in other segments (e.g., inaccessible segments) of the bank of memory cells in a same row as the memory cell. In some such applications, the bank of memory cells may be prohibited from opening another row during performing the access operation. However, performing the access operation on the memory cell may be associated with causing increased latency (e.g., associated with write-back time, precharge time) for accessing the bank of memory cells due to preventing other access operations from being performed in parallel. To address these disadvantages, some memory devices (e.g., as in previous implementations) may implement an increased quantity of banks to allow parallel access of memory cells. However, increasing the quantity of banks may be associated with increasing costs or decreasing spatial efficiency, or both of a memory device.

However, the bank of memory cells 200 may be operable to support concurrently accessing two or more segments 215 in a same row 201 of the bank of memory cells 200, based on determining whether the two or more segments 215 are concurrently inaccessible. For example, during a concurrent access operation on two memory cells 225 in two segments 215 of the same row 201, a controller (e.g., not shown, hardware, a memory system controller 155 or a local memory controller 165, as described with reference to FIG. 1) coupled with the bank of memory cells 200 may determine whether the segments 215 may be accessed concurrently. In some cases, the two segments 215 (e.g., adjacent segments) may not be concurrently accessible due to the two segments 215 being coupled with a same sense component 220 (e.g., due to the sense component 220 being inoperable to sense both of the two segments 215 concurrently). In some such cases, the controller may determine whether the two segments 215 may be concurrently accessed, based on determining whether the two segments 215 are coupled with a same sense component 220.

In some cases, if the segments 215 are concurrently accessible (e.g., one segment is an active segment, one segment is an accessible segment), the concurrent access operation may be performed on the two memory cells 225. However, in other cases, if the segments 215 are concurrently inaccessible (e.g., one segment is an active segment, one segment is an inaccessible segment), a later access command (e.g., an access command received at least partially after receiving a prior access command) may be discarded, and the concurrent access operation may not be performed on the two memory cells 225. In some examples, if the segments 215 are concurrently inaccessible, the later access command may be stored to a command buffer, and the later access operation may be performed in accordance with the later access command after completing the prior access operation (e.g., wait to perform the later access command until the corresponding segment 215 is accessible). In either case, the controller may transmit an indication (e.g., an activate command flag) to a host device coupled with the controller (e.g., or the bank of memory cells 200) based on determining whether the concurrent access operation may be performed. For example, if the concurrent access operation may not be performed, the controller may transmit an indication that the corresponding access operation has been prohibited (e.g., blocked). Conversely, if the concurrent access operation may be performed, the controller may transmit an indication that the concurrent access operation has been permitted (e.g., allowed). The controller may transmit the command prior to performing the concurrent access operation or after performing the concurrent access operation.

For example, the controller coupled with the bank of memory cells 200 may receive a first access command (e.g., an activate command) to access (e.g., read, write-back) a memory cell 225 in the segment 215-b (e.g., an active segment 215). In some cases, during performing a write-back operation (e.g., rewriting the logic state read from the memory cell in response to the first access command) on the memory cell 225, the controller may receive a second access command to access (e.g., read, write-back) a memory cell 225 in the segment 215-a or the segment 215-c (e.g., inaccessible segments). However, the segment 215-a and the segment 215-c may be concurrently inaccessible with the segment 215-b, due to the segment 215-a sharing the sense component 220-a with the segment 215-b, and the segment 215-c sharing the sense component 220-b with the segment 215-b. Thus, the controller may refrain from performing the second access command, and may either discard the second access command or temporarily delay the second access command until the first access command is completed (e.g., the write-back operation on the memory cell 225 is completed, the precharge on the corresponding digit line 210 is completed). The controller may transmit an indication that the second access command is prohibited based on determining the segment 215-a and the segment 215-c are concurrently inaccessible with the segment 215-b. In some cases, during performing the write-back operation (e.g., rewriting the logic state read from the memory cell in response to the first access command) on the memory cell 225, the controller may receive a second access command to access (e.g., read, write-back) another memory cell 225 in the segment 215-b (e.g., the active segment). However, the other memory cell 225 may be concurrently inaccessible with the memory cell 225, due to the segment 215-b being an active segment. Thus, the controller may refrain from performing the second access command, and may either discard the second access command or temporarily delay the second access command until the first access command is completed (e.g., the write-back operation on the memory cell 225 is completed, the precharge on the corresponding digit line 210 is completed). The controller may transmit an indication that the second access command is prohibited based on determining the segment 215-b is the active segment.

However, in other cases, during performing the write-back operation on the memory cell 225, the controller may receive a third access command to access a memory cell 225 in a segment 215-d (e.g., an accessible segment). The segment 215-b and the segment 215-d may be concurrently accessible, due to the segment 215-b and the segment 215-d not sharing a sense component 220. Thus, the controller may perform the third access command. The controller may transmit an indication that the third access command is permitted based on determining the segment 215-d is concurrently accessible with the segment 215-a. A same methodology may be applied for accessing three or more segments concurrently.

In accordance with examples as described herein, accessing memory cells 225 in two or more segments 215 of the same row 201 concurrently may decrease latency (e.g., associated with write-back time) for accessing the bank of memory cells 200 (e.g., compared to previous implementations) without increasing a quantity of banks at a memory device implementing the bank of memory cells 200 (e.g., otherwise associated with previous implementations), thereby conserving costs and space at the memory device. In some examples, configuring the bank of memory cells 200 to support concurrent access of the same row 201 may increase a concurrent accessibility of the bank of memory cells to 90% (e.g., may access 29 out of 32 segments 215 concurrently with a segment 215), such that a second access command may be operable to access 90% of the segments 215 in the row 201.

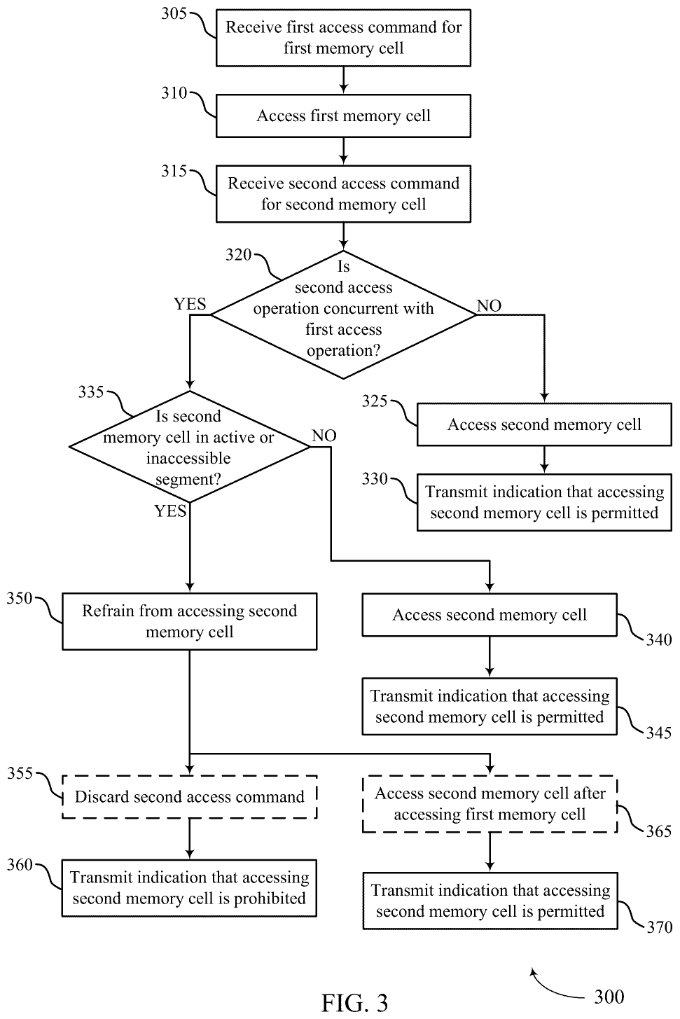

FIG. 3 shows an example of a process flow 300 that supports accessing multiple segments of memory systems in accordance with examples as disclosed herein. The process flow 300 may illustrate aspects or operations of a system 100 or a bank of memory cells 200, as described with reference to FIGS. 1 and 2, respectively. For example, the process flow 300 may illustrate operations performed on the bank of memory cells 200 facilitated by a controller, such a memory system controller 155 or a local memory controller 165. In the following description of the process flow 300, the methods, techniques, processes, and operations may be performed in different orders or at different times. Further, certain operations may be left out of the process flow 300, or other operations may be added to the process flow 300. The process flow 300 may depict operations associated with concurrently accessing two or more segments 215 of a same row 201 of the bank of memory cells 200.

At 305, the controller may receive a first access command. The first access command may be received from a host device coupled with the controller, such as a host system 105. The first access command may indicate the controller to perform a first access operation (e.g., a read operation, a write-back operation) on a first memory cell 225 of the bank of memory cells 200. In some examples, the first access command may be an example of an activate command, such that the first access command may indicate to perform a write-back operation on the first memory cell 225. In some implementations, the first access command may identify (e.g., include a mapping) the first memory cell 225 is associated with a first segment 215 (e.g., a segment 215-b, an active segment).

At 310, the controller may access the first memory cell 225. Accessing the first memory cell 225 may include reading a logic state from the first memory cell 225 and transmitting the logic state to the host device, then performing a write-back operation to rewrite the logic state to the first memory cell 225. In some cases, performing the write-back operation may include applying a precharge pulse to a digit line 210 associated with the first segment 215 (e.g., after performing the write-back operation). In some examples, the controller may determine the first memory cell 225 is associated with the first segment 215 prior to accessing the first memory cell 225. For example, the controller may access a mapping table including mappings between segments 215 and memory cells 225 to determine a mapping between the first memory cell 225 and the first segment 215. In other examples, the controller may use the first access command to identify the first memory cell 225 is associated with the first segment 215 prior to accessing the first memory cell 225. Accessing the first memory cell 225 may cause the first segment 215 to become an active segment 215.

At 315, the controller may receive a second access command. The second access command may be received from the host device and may indicate the controller to perform a second access operation (e.g., a read operation, write operation, a write-back operation) on a second memory cell 225 of the bank of memory cells 200. In some examples, the second access command may be an example of an activate command. In some implementations, the second access command may identify the second memory cell 225 is associated with the first segment 215 or a second segment 215 (e.g., a segment 215-c, a segment 215-d).

At 320, the controller may determine whether the second access operation is at least partially concurrent with the first access operation. For example, the controller may determine whether a time interval for performing the second access operation overlaps with a time interval for performing the first access operation. In some cases, the controller may determine that performing the second access operation occurs at least partially concurrently with performing the first access operation, and the process flow 300 may continue to step 335. In some such cases, the controller may determine that performing the second access operation occurs at least partially concurrently with performing the first access operation based on determining the second access command was received during performing the first access operation. In other cases, the controller may determine that performing the second access operation occurs after performing the first access operation, and the process flow 300 may continue to step 325. In some such cases, the controller may determine that performing the second access operation occurs after performing the first access operation based on determining the second access command was received after performing (e.g., completing) the first access operation.

At 325, the controller may access the second memory cell 225, based on determining that performing the second access operation occurs after performing the first access operation. Accessing the second memory cell 225 may include reading a logic state from the second memory cell 225 and transmitting the logic state to the host device, then performing a write-back operation to rewrite the logic state to the second memory cell 225. In some cases, performing the write-back operation may include applying a precharge pulse to a digit line 210 associated with the second memory cell 225 (e.g., after performing the write-back operation). In some examples, the controller may determine the second memory cell 225 is associated with the first segment 215 or the second segment 215 prior to accessing the second memory cell 225. For example, the controller may access the mapping table including mappings between segments 215 and memory cells 225 to determine a mapping between the second memory cell 225 and the first segment 215 or the second segment 215. In other examples, the controller may use the second access command to identify the second memory cell 225 is associated with the first segment 215 or the second segment 215 prior to accessing the second memory cell 225.

At 330, the controller may transmit an indication to the host device that accessing the second memory cell 225 is permitted. In some cases, the controller may transmit the indication prior to or after accessing the second memory cell 225 at step 325. In some implementations, the indication may be an example of an activate command flag, such that the indication may indicate that the activate command was permitted.

At 335, the controller may determine whether the second memory cell 225 is associated with the first segment 215 (e.g., the active segment) or a concurrently inaccessible segment 215 (e.g., a segment 215-a, a segment 215-c). For example, the controller may identify the second memory cell 225 is associated with the second segment 215 (e.g., based on the second access command, or based on determining), and the controller may determine whether the second segment 215 is concurrently inaccessible with the first segment 215 based on determining whether the first segment 215 and the second segment 215 share a sense component 220 (e.g., adjacency between the first segment 215 and the second segment 215). In some examples, the controller may determine whether the second segment 215 is concurrently inaccessible with the first segment 215 based on identifying mappings (e.g., from the mapping table) between the first memory cell 225 and the first segment 215, and the second memory cell 225 and the second segment 215.

In some cases, the controller may determine the second segment 215 is concurrently inaccessible (e.g., the second segment 215 is an inaccessible segment) with the first segment 215 and the process flow 300 may continue to step 350. For example, the controller may determine the second segment 215 (e.g., the segment 215-c) is adjacent to the first segment 215 (e.g., the segment 215-b) and the controller may determine the second segment 215 is concurrently inaccessible with the first segment 215 (e.g., the second segment 215 and the first segment 215 share a sense component 220). In some cases, the controller may determine the second memory cell 225 is associated with the first segment 215, and the process flow 300 may continue to step 350 (e.g., due to the first memory cell 225 and the second memory cell 225 sharing a sense component 220). In other cases, the controller may determine the second memory cell 225 is concurrently accessible with the first memory cell 225 and the process flow 300 may continue to step 340. In some examples, the controller may determine the second segment 215 concurrently accessible (e.g., the second segment is an accessible segment) with the first segment 215. For instance, the controller may determine the second segment 215 (e.g., the segment 215-d) is not adjacent to the first segment 215 (e.g., the segment 215-b) and the controller may determine the second segment 215 is concurrently accessible with the first segment 215 (e.g., the second segment 215 and the first segment 215 do not share a sense component 220).

At 340, the controller may access the second memory cell 225, based on determining that the second memory cell 225 is concurrently accessible with the first memory cell 225. Accessing the second memory cell 225 may include reading a logic state from the second memory cell 225 and transmitting the logic state to the host device, then performing a write-back operation to rewrite the logic state to the second memory cell 225. In some cases, performing the write-back operation may include applying a precharge pulse to a digit line 210 associated with the second memory cell 225 (e.g., after performing the write-back operation).

At 345, the controller may transmit an indication to the host device that accessing the second memory cell 225 is permitted. In some cases, the controller may transmit the indication prior to or after accessing the second memory cell 225 at step 325. In some implementations, the indication may be an example of an activate command flag, such that the indication may indicate that the activate command was permitted.

At 350, the controller may refrain from accessing the second memory cell 225, based on determining that the second memory cell 225 is concurrently inaccessible with the first memory cell 225 (e.g., the first segment 215 and the second segment 215 are concurrently inaccessible, the second segment is an inaccessible segment). The process flow 300 may continue to step 355 or step 365 based on a configuration of the controller or an indication from the host device.

At 355, as part of refraining from accessing the second memory cell 225, the controller may discard the second access command. The controller may not perform the second access operation based on discarding the second access command.

At 360, the controller may transmit an indication to the host device that accessing the second memory cell 225 is prohibited. In some cases, the controller may transmit the indication prior to or after discarding the second access command at step 355. In some implementations, the indication may be an example of an activate command flag, such that the indication may indicate that the activate command was prohibited.

At 365, as part of refraining from accessing the second memory cell 225, the controller may temporarily suspend the second access command. Suspending the second access command may include storing the second access command to a command buffer or a command cache and refraining from executing the second access command for a duration associated with performing the first access operation. After the first access operation is completed, the second access command may be removed from the command buffer or the command cache and executed by the controller, where executing the second access command includes accessing the second memory cell 225.

At 370, the controller may transmit an indication to the host device that accessing the second memory cell 225 is permitted. In some cases, the controller may transmit the indication prior to or after executing the second access command at step 365. In some implementations, the indication may be an example of an activate command flag, such that the indication may indicate that the activate command was permitted.

In accordance with examples as described herein, performing the process flow 300 may support accessing memory cells 225 in two or more segments 215 of the same row 201 concurrently, which may decrease latency for accessing the bank of memory cells 200 (e.g., compared to previous implementations) without increasing a quantity of banks at a memory device implementing the bank of memory cells 200 (e.g., otherwise associated with previous implementations), thereby conserving costs and space at the memory device.

FIG. 4 shows a block diagram 400 of a memory device 420 that supports accessing multiple segments of memory systems in accordance with examples as disclosed herein. The memory device 420 may be an example of aspects of a memory device as described with reference to FIGS. 1 through 3. The memory device 420, or various components thereof, may be an example of means for performing various aspects of accessing multiple segments of memory systems as described herein. For example, the memory device 420 may include a reception component 425, an access component 430, a determination component 435, a transmission component 440, or any combination thereof. Each of these components may communicate, directly or indirectly, with one another (e.g., via one or more buses).

The reception component 425 may be configured as or otherwise support a means for receiving a first command to access a first memory cell of a bank of memory cells. The access component 430 may be configured as or otherwise support a means for accessing an active segment of the bank that is associated with the first memory cell based at least in part on receiving the first command. In some examples, the reception component 425 may be configured as or otherwise support a means for receiving a second command to access a second memory cell of the bank at least partially concurrently with accessing the active segment. The determination component 435 may be configured as or otherwise support a means for determining, based at least in part on receiving the second command to access the second memory cell, whether the second memory cell is associated with the active segment or one or more inaccessible segments of the bank, where the one or more inaccessible segments are inaccessible while the active segment is being accessed. In some examples, the access component 430 may be configured as or otherwise support a means for accessing the second memory cell based at least in part on determining that the second memory cell is associated with an accessible segment of the bank different than the active segment and the one or more inaccessible segments.

In some examples, the reception component 425 may be configured as or otherwise support a means for receiving a third command to access a third memory cell of the bank, where the third memory cell is associated with the one or more inaccessible segments. In some examples, the determination component 435 may be configured as or otherwise support a means for determining whether accessing the third memory cell occurs at least partially concurrently with accessing the second memory cell. In some examples, the determination component 435 may be configured as or otherwise support a means for determining whether the third memory cell is associated with the active segment or the one or more inaccessible segments. In some examples, the access component 430 may be configured as or otherwise support a means for refraining from accessing the third memory cell concurrently with accessing the second memory cell based at least in part on determining that accessing the third memory cell occurs at least partially concurrently with accessing the second memory cell and determining that the third memory cell is associated with the one or more inaccessible segments.

In some examples, the transmission component 440 may be configured as or otherwise support a means for transmitting an indication that the third memory cell is prohibited for access based at least in part on determining that accessing the third memory cell occurs at least partially concurrently with accessing the second memory cell and determining that the third memory cell is associated with the one or more inaccessible segments.

In some examples, to support refraining from accessing the third memory cell, the access component 430 may be configured as or otherwise support a means for refraining from accessing the third memory cell until after a write back operation on the second memory cell has been completed.

In some examples, to support refraining from accessing the third memory cell, the access component 430 may be configured as or otherwise support a means for discarding the third command.

In some examples, the transmission component 440 may be configured as or otherwise support a means for transmitting an indication that the second memory cell is permitted for access based at least in part on determining that the second memory cell is associated with the accessible segment.

In some examples, accessing the first memory cell includes performing a write-back operation on the first memory cell after reading the first memory cell.

In some examples, the first command and the second command are activate commands.

In some examples, the access component 430 may be configured as or otherwise support a means for accessing a table including mappings between segments of memory cells and addresses of memory cells, where determining whether the second memory cell is associated with the active segment or the one or more inaccessible segments is based at least in part on accessing the table.

In some examples, each segment of memory cells is associated with a respective digit line of the bank of memory cells.

In some examples, the bank of memory cells include dynamic random access memory cells.

In some examples, accessing the second memory cell includes accessing the accessible segment associated with the second memory cell. In some examples, accessing the accessible segment includes accessing a word line of the bank of memory cells and a digit line associated with the accessible segment.

In some examples, the active segment and the one or more inaccessible segments share one or more respective sense components.

FIG. 5 shows a flowchart illustrating a method 500 that supports accessing multiple segments of memory systems in accordance with examples as disclosed herein. The operations of method 500 may be implemented by a memory device or its components as described herein. For example, the operations of method 500 may be performed by a memory device as described with reference to FIGS. 1 through 4. In some examples, a memory device may execute a set of instructions to control the functional elements of the device to perform the described functions. Additionally, or alternatively, the wireless memory device may perform aspects of the described functions using special-purpose hardware.

At 505, the method may include receiving a first command to access a first memory cell of a bank of memory cells. The operations of 505 may be performed in accordance with examples as disclosed herein. In some examples, aspects of the operations of 505 may be performed by a reception component 425 as described with reference to FIG. 4.

At 510, the method may include accessing an active segment of the bank that is associated with the first memory cell based at least in part on receiving the first command. The operations of 510 may be performed in accordance with examples as disclosed herein. In some examples, aspects of the operations of 510 may be performed by an access component 430 as described with reference to FIG. 4.

At 515, the method may include receiving a second command to access a second memory cell of the bank at least partially concurrently with accessing the active segment. The operations of 515 may be performed in accordance with examples as disclosed herein. In some examples, aspects of the operations of 515 may be performed by a reception component 425 as described with reference to FIG. 4.

At 520, the method may include determining, based at least in part on receiving the second command to access the second memory cell, whether the second memory cell is associated with the active segment or one or more inaccessible segments of the bank, where the one or more inaccessible segments are inaccessible while the active segment is being accessed. The operations of 520 may be performed in accordance with examples as disclosed herein. In some examples, aspects of the operations of 520 may be performed by a determination component 435 as described with reference to FIG. 4.

At 525, the method may include accessing the second memory cell based at least in part on determining that the second memory cell is associated with an accessible segment of the bank different than the active segment and the one or more inaccessible segments. The operations of 525 may be performed in accordance with examples as disclosed herein. In some examples, aspects of the operations of 525 may be performed by an access component 430 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving a first command to access a first memory cell of a bank of memory cells; accessing an active segment of the bank that is associated with the first memory cell based at least in part on receiving the first command; receiving a second command to access a second memory cell of the bank at least partially concurrently with accessing the active segment; determining, based at least in part on receiving the second command to access the second memory cell, whether the second memory cell is associated with the active segment or one or more inaccessible segments of the bank, where the one or more inaccessible segments are inaccessible while the active segment is being accessed; and accessing the second memory cell based at least in part on determining that the second memory cell is associated with an accessible segment of the bank different than the active segment and the one or more inaccessible segments.

Aspect 2: The method, apparatus, or non-transitory computer-readable medium of aspect 1, further including operations, features, circuitry, logic, means, or instructions, or any combination thereof for receiving a third command to access a third memory cell of the bank, where the third memory cell is associated with the one or more inaccessible segments; determining whether accessing the third memory cell occurs at least partially concurrently with accessing the second memory cell; determining whether the third memory cell is associated with the active segment or the one or more inaccessible segments; and refraining from accessing the third memory cell concurrently with accessing the second memory cell based at least in part on determining that accessing the third memory cell occurs at least partially concurrently with accessing the second memory cell and determining that the third memory cell is associated with the one or more inaccessible segments.

Aspect 3: The method, apparatus, or non-transitory computer-readable medium of aspect 2, further including operations, features, circuitry, logic, means, or instructions, or any combination thereof for transmitting an indication that the third memory cell is prohibited for access based at least in part on determining that accessing the third memory cell occurs at least partially concurrently with accessing the second memory cell and determining that the third memory cell is associated with the one or more inaccessible segments.

Aspect 4: The method, apparatus, or non-transitory computer-readable medium of any of aspects 2 through 3, where refraining from accessing the third memory cell includes operations, features, circuitry, logic, means, or instructions, or any combination thereof for refraining from accessing the third memory cell until after a write back operation on the second memory cell has been completed.

Aspect 5: The method, apparatus, or non-transitory computer-readable medium of any of aspects 2 through 4, where refraining from accessing the third memory cell includes operations, features, circuitry, logic, means, or instructions, or any combination thereof for discarding the third command.

Aspect 6: The method, apparatus, or non-transitory computer-readable medium of any of aspects 1 through 5, further including operations, features, circuitry, logic, means, or instructions, or any combination thereof for transmitting an indication that the second memory cell is permitted for access based at least in part on determining that the second memory cell is associated with the accessible segment.

Aspect 7: The method, apparatus, or non-transitory computer-readable medium of any of aspects 1 through 6, where accessing the first memory cell includes performing a write-back operation on the first memory cell after reading the first memory cell.

Aspect 8: The method, apparatus, or non-transitory computer-readable medium of any of aspects 1 through 7, where the first command and the second command are activate commands.

Aspect 9: The method, apparatus, or non-transitory computer-readable medium of any of aspects 1 through 8, further including operations, features, circuitry, logic, means, or instructions, or any combination thereof for accessing a table including mappings between segments of memory cells and addresses of memory cells, where determining whether the second memory cell is associated with the active segment or the one or more inaccessible segments is based at least in part on accessing the table.

Aspect 10: The method, apparatus, or non-transitory computer-readable medium of any of aspects 1 through 9, where each segment of memory cells is associated with a respective digit line of the bank of memory cells.

Aspect 11: The method, apparatus, or non-transitory computer-readable medium of any of aspects 1 through 10, where the bank of memory cells include dynamic random access memory cells.

Aspect 12: The method, apparatus, or non-transitory computer-readable medium of any of aspects 1 through 11, where accessing the second memory cell includes accessing the accessible segment associated with the second memory cell and accessing the accessible segment includes accessing a word line of the bank of memory cells and a digit line associated with the accessible segment.

Aspect 13: The method, apparatus, or non-transitory computer-readable medium of any of aspects 1 through 12, where the active segment and the one or more inaccessible segments share one or more respective sense components.

It should be noted that the methods described herein describe possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (e.g., in conductive contact with, connected with, coupled with) one another if there is any electrical path (e.g., conductive path) between the components that can, at any time, support the flow of signals (e.g., charge, current, voltage) between the components. At any given time, a conductive path between components that are in electronic communication with each other (e.g., in conductive contact with, connected with, coupled with) may be an open circuit or a closed circuit based on the operation of the device that includes the connected components. A conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to condition of moving from an open-circuit relationship between components in which signals are not presently capable of being communicated between the components (e.g., over a conductive path) to a closed-circuit relationship between components in which signals are capable of being communicated between components (e.g., over the conductive path). When a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other when the switch is open. When a controller isolates two components, the controller affects a change that prevents signals from flowing between the components using a conductive path that previously permitted signals to flow.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component (e.g., a transistor) discussed herein may represent a field-effect transistor (FET), and may comprise a three-terminal component including a source (e.g., a source terminal), a drain (e.g., a drain terminal), and a gate (e.g., a gate terminal). The terminals may be connected to other electronic components through conductive materials (e.g., metals, alloys). The source and drain may be conductive, and may comprise a doped (e.g., heavily-doped, degenerate) semiconductor region. The source and drain may be separated by a doped (e.g., lightly-doped) semiconductor region or channel. If the channel is n-type (e.g., majority carriers are electrons), then the FET may be referred to as a n-type FET. If the channel is p-type (e.g., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” when a voltage greater than or equal to the transistor's threshold voltage is applied to the transistor gate. The transistor may be “off” or “deactivated” when a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

The functions described herein may be implemented in hardware, software executed by a processor, firmware, or any combination thereof. If implemented in software executed by a processor, the functions may be stored on or transmitted over as one or more instructions (e.g., code) on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

For example, the various illustrative blocks and modules described in connection with the disclosure herein may be implemented or performed with a processor, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or any type of processor. A processor may also be implemented as a combination of computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a computer, or a processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. An apparatus, comprising:
a bank of memory cells comprising a plurality of segments; and
a controller coupled with the bank of memory cells and configured to cause the apparatus to:
receive a first command to access a first memory cell of the bank of memory cells;
access an active segment of the bank that is associated with the first memory cell based at least in part on receiving the first command;
receive a second command to access a second memory cell of the bank at least partially concurrently with accessing the active segment;
determine, based at least in part on receiving the second command to access the second memory cell, whether the second memory cell is associated with the active segment or one or more inaccessible segments of the bank, wherein the one or more inaccessible segments are inaccessible while the active segment is being accessed; and
access the second memory cell based at least in part on determining that the second memory cell is associated with an accessible segment of the bank different than the active segment and the one or more inaccessible segments.

2. The apparatus of claim 1, wherein the controller is further configured to cause the apparatus to:
receive a third command to access a third memory cell of the bank, wherein the third memory cell is associated with the one or more inaccessible segments;
determine whether accessing the third memory cell occurs at least partially concurrently with accessing the second memory cell;
determine whether the third memory cell is associated with the active segment or the one or more inaccessible segments; and
refrain from accessing the third memory cell concurrently with accessing the second memory cell based at least in part on determining that accessing the third memory cell occurs at least partially concurrently with accessing the second memory cell and determining that the third memory cell is associated with the one or more inaccessible segments.

3. The apparatus of claim 2, wherein the controller is further configured to cause the apparatus to:
transmit an indication that the third memory cell is prohibited for access based at least in part on determining that accessing the third memory cell occurs at least partially concurrently with accessing the second memory cell and determining that the third memory cell is associated with the one or more inaccessible segments.

4. The apparatus of claim 2, wherein refraining from accessing the third memory cell is configured to cause the apparatus to:
refrain from accessing the third memory cell until after a write back operation on the second memory cell has been completed.

5. The apparatus of claim 2, wherein refraining from accessing the third memory cell is configured to cause the apparatus to:
discard the third command.

6. The apparatus of claim 1, wherein the controller is further configured to cause the apparatus to:
transmit an indication that the second memory cell is permitted for access based at least in part on determining that the second memory cell is associated with the accessible segment.

7. The apparatus of claim 1, wherein accessing the first memory cell comprises performing a write-back operation on the first memory cell after reading the first memory cell.

8. The apparatus of claim 1, wherein the first command and the second command are activate commands.

9. The apparatus of claim 1, wherein the controller is further configured to cause the apparatus to:
access a table comprising mappings between segments of memory cells and addresses of memory cells,
wherein determining whether the second memory cell is associated with the active segment or the one or more inaccessible segments is based at least in part on accessing the table.

10. The apparatus of claim 1, wherein each segment of memory cells is associated with a respective digit line of the bank of memory cells.

11. The apparatus of claim 1, wherein the bank of memory cells comprise dynamic random access memory cells.

12. The apparatus of claim 1, wherein:
accessing the second memory cell comprises accessing the accessible segment associated with the second memory cell, and
accessing the accessible segment comprises accessing a word line of the bank of memory cells and a digit line associated with the accessible segment.

13. The apparatus of claim 1, wherein the active segment and the one or more inaccessible segments share one or more respective sense components.

14. A non-transitory computer-readable medium storing code, the code comprising instructions executable by a processor to:
receive a first command to access a first memory cell of a bank of memory cells;
access an active segment of the bank that is associated with the first memory cell based at least in part on receiving the first command;
receive a second command to access a second memory cell of the bank at least partially concurrently with accessing the active segment;
determine, based at least in part on receiving the second command to access the second memory cell, whether the second memory cell is associated with the active segment or one or more inaccessible segments of the bank, wherein the one or more inaccessible segments are inaccessible while the active segment is being accessed; and
access the second memory cell based at least in part on determining that the second memory cell is associated with an accessible segment of the bank different than the active segment and the one or more inaccessible segments.

15. The non-transitory computer-readable medium of claim 14, wherein the instructions are further executable by the processor to:
receive a third command to access a third memory cell of the bank, wherein the third memory cell is associated with the one or more inaccessible segments;
determine whether accessing the third memory cell occurs at least partially concurrently with accessing the second memory cell;
determine whether the third memory cell is associated with the active segment or the one or more inaccessible segments; and
refrain from accessing the third memory cell concurrently with accessing the second memory cell based at least in part on determining that accessing the third memory cell occurs at least partially concurrently with accessing the second memory cell and determining that the third memory cell is associated with the one or more inaccessible segments.

16. The non-transitory computer-readable medium of claim 15, wherein the instructions are further executable by the processor to:
transmit an indication that the third memory cell is prohibited for access based at least in part on determining that accessing the third memory cell occurs at least partially concurrently with accessing the second memory cell and determining that the third memory cell is associated with the one or more inaccessible segments.

17. The non-transitory computer-readable medium of claim 14, wherein the instructions are further executable by the processor to:
transmit an indication that the second memory cell is permitted for access based at least in part on determining that the second memory cell is associated with the accessible segment.

18. The non-transitory computer-readable medium of claim 14, wherein accessing the first memory cell comprises performing a write-back operation on the first memory cell after reading the first memory cell.

19. The non-transitory computer-readable medium of claim 14, wherein the instructions are further executable by the processor to:
access a table comprising mappings between segments of memory cells and addresses of memory cells,
wherein determining whether the second memory cell is associated with the active segment or the one or more inaccessible segments is based at least in part on accessing the table.

20. A method, comprising:
receiving a first command to access a first memory cell of a bank of memory cells;
accessing an active segment of the bank that is associated with the first memory cell based at least in part on receiving the first command;
receiving a second command to access a second memory cell of the bank at least partially concurrently with accessing the active segment;
determining, based at least in part on receiving the second command to access the second memory cell, whether the second memory cell is associated with the active segment or one or more inaccessible segments of the bank, wherein the one or more inaccessible segments are inaccessible while the active segment is being accessed; and
accessing the second memory cell based at least in part on determining that the second memory cell is associated with an accessible segment of the bank different than the active segment and the one or more inaccessible segments.
